(19) United States
(12) Patent Application Publication
(10) Pub. No.: US 2024/0409442 A1
(43) Pub. Date: Dec. 12, 2024

(54) Method for in situ regeneration of an adsorbent medium

(71) Applicant: SUEZ INTERNATIONAL, Paris La Défense (FR)

(72) Inventors: Olivier DANEL, Le Vésinet (FR); Isabelle BAUDIN, Nanterre (FR); Laurent GUEY, Puteaux (FR)

(73) Assignee: SUEZ INTERNATIONAL, Paris La Défense (FR)

(21) Appl. No.: 18/576,608

(22) PCT Filed: Jul. 1, 2022
(86) PCT No.: PCT/EP2022/068348

§ 371 Date: Apr. 24, 2024

(30) Foreign Application Priority Data
Jul. 2, 2021 (FR) FR2107195

(51) Int. Cl. C02F 1/28

(52) U.S. Cl. CPC C02F 1/283; C02F 2303/16; C02F 2305/00

(57) ABSTRACT

The invention relates to a method for regenerating a bed of adsorbent medium in an adsorption reactor, implemented in a fluid treatment unit, said bed of adsorbent medium prior to regeneration being a fresh adsorbent medium, said regeneration method comprising at least one chemical regeneration step wherein the bed of adsorbent medium is brought into contact with a regeneration solution, said bed of fresh adsorbent medium being characterized in that: it has an actual reduction rate of at least one target pollutant ranging from 40% to 80%, and/or the bed volume treated by said adsorbent medium is from 20,000 to 100,000 BVT, preferably from 30,000 to 75,000 BVT, more preferably from 40,000 to 60,000 BVT, and/or it has an iodine value ranging from 500 to 800 mg/g. The invention also relates to a fluid-treatment method implementing said regeneration method, as well as to a fluid-treatment plant suitable for carrying out the fluid-treatment method according to the invention.

### TECHNICAL FIELD OF THE INVENTION

The invention relates to the field of fluid treatment systems, in particular for water, implementing a step of adsorption onto an adsorbent medium. More particularly, the invention relates to a method for regenerating an adsorbent medium directly within the adsorption reactor, as well as a method for treating a fluid implementing said regeneration method. Finally, the invention also relates to a plant for implementing the regeneration method and a plant for implementing the fluid-treatment method.

### STATE OF THE ART

For the treatment of fluid, and in particular for the production of drinking water or the treatment of effluents, a reduction of the organic contaminants contained in raw water or an effluent can be proposed by means of a step of adsorption of this material onto an adsorbent medium.

Indeed, the increasing load of organic contaminants (natural organic matter and micro-pollutants of anthropic or natural origin) observed in resources is leading drinking water producers and effluent processors to redevelop their treatment systems, which have become unsuitable for quality objectives. This growing load of organic contaminants is also requiring drinking water producers to design a new treatment plant. Finally, effluent processors, whether for effluents from industry or the tertiary sector before discharge into a natural environment or effluents to be treated so as to make them drinkable (waste water) directly or indirectly (reuse of waste water), can also take advantage of treatment taking into account a greater presence of organic contaminants. Taking this significant pollution by organic contaminants into account can in particular pass through the addition of a refining system, from the design stage or during remediation, in particular using activated carbon, such as, in particular, filtration and/or adsorption by a bed of granular activated carbon (GAC).

In this field of water treatment, taking the emergence of organic micropollutants of synthetic origin into account still remains to be improved, in particular when they are present in small amounts.

In particular, some of these emerging pollutants have a low adsorption, whether they are pollutants in the form of small molecules, polar molecules, or hydrophilic molecules. These in particular involve pesticide metabolites, which can thus be found downstream of the adsorption step, such as an adsorption step with granular activated carbon. The level of these emerging pollutants at the end of the treatment system can then exceed regulatory thresholds if these pollutants are specifically regulated, or in any case may present a risk to be anticipated for emerging pollutants that are not yet regulated.

In fact, the adsorption capacity of the adsorbents, such as activated carbon, decreases as they are used to adsorb pollutants.

The manufacturers carry out renewal and/or regeneration operations of the adsorbent medium in order to increase the adsorption capacity of the adsorbent medium.

Document US 2017/0232421 describes a method for in situ regeneration of activated carbon charged with trihalomethane.

Document US 2008/0286193 describes a method for regenerating activated carbon using a regeneration solution comprising ethanol, sodium hydroxide and hydrogen peroxide.

The regeneration methods of the prior art are generally implemented on totally saturated adsorbent media and/or with complex and expensive regeneration solutions.

There is therefore a need to propose a method for regeneration of an adsorbent medium that is simple to implement and making it possible to obtain in fine an optimized method for treating a fluid, with a satisfactory reduction rate of pollutants throughout the treatment method.

### SUMMARY OF THE INVENTION

The invention relates to a method for regenerating a bed of adsorbent medium in an adsorption reactor, implemented in a fluid treatment unit, said bed of adsorbent medium prior to regeneration being a fresh adsorbent medium, said regeneration method comprising at least one chemical regeneration step wherein the bed of adsorbent medium is brought into contact with a regeneration solution, said bed of fresh adsorbent medium being characterized in that:
it has an actual reduction rate of at least one target pollutant ranging from 40% to 80%, and/or
the bed volume treated by said adsorbent medium ranges from 20,000 to 100,000 BVT (bed volume treated, more commonly referred to as “bed volume,” or BV), preferably from 30,000 to 75,000 BVT, still more preferably from 40,000 to 60,000 BVT, and/or
it has an iodine value ranging from 500 to 800 mg/g.

Preferably, the regeneration solution comprises an aqueous sodium hydroxide solution, preferably consists of an aqueous sodium hydroxide solution.

According to one embodiment of the invention, the regeneration solution is circulated in a closed loop through the activated carbon bed within the adsorption reactor.

According to one embodiment of the invention, the regeneration solution is at a temperature of less than or equal to 60° C., preferably ranging from 20 to 50° C., even more preferably from 30 to 40° C.

According to one embodiment of the invention, at the end of contact with the regeneration solution, the adsorbent medium bed is rinsed using a rinsing solution, said rinsing solution preferably comprising water, or even consisting of water.

Preferably, the chemical regeneration step further comprises a dewatering step at the end of the contact step with the regeneration solution, said dewatering step being carried out before the rinsing step.

According to one embodiment of the invention, the regeneration method further comprises a step of electrochemical regeneration of the adsorbent medium carried out before or after or during the chemical regeneration step.

According to one embodiment of the invention,
the fluid to be treated is chosen from water, urban effluent, industrial effluent; preferably, the fluid to be treated is water, and/or
the adsorbent medium is chosen from granular activated carbon, anion exchange resin, biomaterials, molecularly imprinted polymers and mineral materials; preferably the adsorbent medium is a granular activated carbon.

According to one embodiment of the invention, the regeneration method is implemented periodically, and comprises a step of determining the next regeneration step based on the freshness of the adsorbent medium, characterized by the reduction rate of at least one target pollutant, and/or by the volume of bed treated and/or by the iodine value of the adsorbent medium.

The invention also relates to a method for treating a fluid in a treatment unit comprising at least one stop phase and at least one production phase, wherein said at least one production phase comprises the passage of a fluid to be treated through an adsorbent medium bed within an adsorption reactor and wherein said at least one stop phase comprises implementing a regeneration method according to the invention.

According to one embodiment of the invention, the fluid treatment method according to the invention further comprises at least one other stop phase wherein the adsorbent medium is washed using a washing solution, said other stop phase not comprising regeneration of the adsorbent medium.

According to one embodiment of the invention, the fluid treatment method further comprises a step of measuring the freshness of the adsorbent medium, preferably implemented by measuring the actual reduction rate in at least one target pollutant by the adsorbent medium, and/or by measuring the bed volume treated by the adsorbent medium, and/or by measuring the iodine value of the adsorbent medium.

The invention finally relates to a fluid treatment unit for implementing the fluid treatment method according to the invention, said treatment unit comprising:
at least one adsorption reactor for pollutants contained in the fluid to be treated, the reactor comprising an adsorbent medium within it, and
means for measuring the freshness of the adsorbent medium.

According to one embodiment of the invention, the adsorbent medium is chosen from granular activated carbon, anion exchange resin, biomaterials, molecularly imprinted polymers and mineral materials; preferably, the adsorbent medium is a granular activated carbon.

According to one embodiment of the invention, the means for measuring the freshness of the adsorbent medium are chosen from a UV spectroscope, a device for measuring dissolved organic carbon, a short bed adsorber test device, and combinations thereof.

The invention allows regeneration of an adsorbent medium by a method simpler than those of the prior art and which consumes less energy. In particular, the method of the invention allows regeneration of the adsorbent medium directly in the adsorption reactor, using less expensive reagents and a simplified plant, since it makes it possible to dispense with heavy adsorbent medium storage facilities. Thus, within the scope of the method of the invention, the adsorbent medium can be regenerated during a stop phase of the treatment method.

The regeneration method according to the invention can be carried out regularly, even on a less saturated (relatively fresh) adsorbent medium.

The regeneration method according to the invention allows improved adsorption capacity of the adsorbent medium, thus allowing the molecules that are difficult to adsorb to be satisfactorily adsorbed throughout the fluid treatment method.

In particular, the method of the invention thus makes it possible to maintain a constant reduction rate during the production time for at least one target pollutant, within the reactor.

In particular, the regeneration method of the invention can be implemented easily and regularly in order to have a nearly constant adsorbent medium quality, in terms of adsorption performance, owing to an in situ regeneration implemented when the adsorbent medium is far from being completely saturated (so-called young adsorbent medium).

### BRIEF DESCRIPTION OF THE FIGURES

FIG. 1 depicts a diagram of a regeneration method according to the invention.

FIG. 2 depicts the efficiency coefficient of the regeneration method implemented with two different waters in the regeneration solution, evaluated for different pollutants.

FIG. 3 depicts the efficiency coefficient of the regeneration method implemented with two concentrations of sodium hydroxide, evaluated for various pollutants.

FIG. 4 depicts the efficiency coefficient of the regeneration method implemented with three different quantities of regeneration solution, evaluated for different pollutants.

FIG. 5 depicts the efficiency coefficient of the regeneration method implemented with three GAC/sodium hydroxide contact times, evaluated for different pollutants.

FIG. 6 depicts the efficiency coefficient of the regeneration method after a rinsing time, evaluated for various pollutants.

FIG. 7 depicts the efficiency coefficient of the regeneration method after a static rinsing step implemented with two different rinsing waters, evaluated for different pollutants.

FIG. 8 depicts the efficiency coefficient of the regeneration method after a dynamic rinsing step implemented with two different rinsing waters, evaluated for organic matter.

FIG. 9 depicts the efficiency coefficient of the regeneration method, when the SAB test is carried out immediately or 24h after a regeneration step, evaluated for different pollutants.

FIG. 10 depicts the efficiency coefficient of the regeneration method, when the rinsing step is carried out immediately or 24h after a regeneration step, evaluated for different pollutants.

### DETAILED DESCRIPTION OF THE INVENTION

The invention relates to a method for regenerating an adsorbent medium implemented in the treatment of a fluid containing pollutants.

More specifically, the invention relates to a method for regenerating a bed of adsorbent medium in an adsorption reactor, implemented in a fluid treatment unit, said bed of adsorbent medium prior to regeneration being a fresh adsorbent medium, said regeneration method comprising at least one chemical regeneration step wherein the bed of adsorbent medium is brought into contact with a regeneration solution, said bed of fresh adsorbent medium being characterized in that:
it has an actual reduction rate of at least one target pollutant ranging from 40% to 80%, and/or
the bed volume treated by said adsorbent medium is from 20,000 to 100,000 BVT, preferably from 30,000 to 75,000 BVT, more preferably from 40,000 to 60,000 BVT, and/or
it has an iodine value greater than or equal to 500 mg/g, in particular ranging from 500 to 800 mg/g.

### Adsorbent Medium

The invention can be implemented on different types of adsorbent media that are capable of removing different types of pollutants.

According to one embodiment of the invention, the adsorbent medium is chosen from the granular activated carbon (GAC), anion exchange resin, biomaterials, molecularly imprinted polymers (MIP) and mineral materials.

Some adsorbents, such as modified clays and cyclodextrin polymers, have also proven to be effective for certain specific micropollutants, such as perfluorinated compounds (PFAs).

According to one particular embodiment, the adsorbent medium is activated carbon. Activated carbon is a material consisting essentially of carbonaceous material with a porous structure. It can be produced in a known manner by pyrolysis of precursors of natural origin (wood, bark, coconut shells, coal, peat, cotton, organic materials of various origins, etc.) or of synthetic origin (polyacrylonitrile (PAN), aramid fibers, etc.) already containing a significant proportion of carbon, this pyrolysis step being followed by a chemical or physical activation step.

The activated carbon is generally effective to remove long-chain PFAS by hydrophobic interaction.

Biomaterials can also be used in the context of the invention, including biochar. Biochar is a composition comprising a pyrolyzed biomass biochar, a biomass biochar produced by hydrothermal carbonization, or a combination thereof. The biomass can be chosen from waste crops, forest waste, algae, animal or human waste, industrial waste, municipal waste, anaerobic digestion waste, plant materials grown for biomass production, or a combination thereof. By way of example, biochar manufactured from hardwood and pine can be envisaged. Biochar from rice balls can also be envisaged, in powder/granular form or in the form of fibers as in document US2019270041A1.

The biochar may be a powdered solid or granules. The biochar may also comprise a powder or a metal salt granule. The metal salt may comprise iron, aluminum, calcium, magnesium, manganese, zinc, copper, or a combination thereof, and in some examples, the metal salt comprises ferrous or ferric cations, ferrate anions, or a combination thereof. In particular embodiments, the metal salt comprises ferric chloride.

According to a particularly preferred embodiment, the determination method of the invention is implemented to determine the remaining capacity of an adsorbent medium chosen from granular activated carbon (GAC), other aforementioned adsorbent media (clays, polymer, biochar, etc.). The method according to the invention can be implemented with different types of GAC.

According to one embodiment, the adsorbent medium is chosen from granular activated carbon, anion exchange resin, biomaterials, molecularly imprinted polymers and mineral materials; preferably, the adsorbent medium is a granular activated carbon.

For example, the granular activated carbon (CAG) that may fall within the scope of the invention will typically have a particle size ranging from 300 to 2,400 μm for at least 85 to 90% by weight of the grains. The dimensions indicated are those of the equivalent diameter of the grains for dry sieving or for wet sieving.

The adsorbent medium is used in at least one adsorption reactor. The fluid treatment unit within the scope of the invention may comprise one or more adsorption reactors, generally at least two adsorption reactors.

### Fluid to be Treated

The fluid to be treated within the scope of the invention may be water, in particular water to be made drinkable, but also an urban or industrial effluent (in particular leachates, which are liquid waste storage effluents), before discharge into a natural environment, or else effluents to be made drinkable (such as waste water, which is urban effluents) either directly or indirectly (reuse of waste water).

Preferably, the fluid to be treated is a liquid, such as water. According to one particularly preferred embodiment, the method of the invention is a drinking water treatment method.

The water to be treated can be qualified as raw water, and may for example be taken from a waterway, in which case reference is made to surface water, or may be withdrawn using a drill, in which case reference is made to underground water. The water to be treated can also be an effluent of urban origin (such as waste water other than urban waste water) or of industrial origin.

In the context of the present invention, the term “pollutant” refers to both organic matter and micropollutants. A micropollutant can be defined as an undesirable substance detectable in the environment at very low concentrations (microgram per liter or even nanogram per liter). The presence of micropollutants in water is due at least in part to human activity (industrial processes, agricultural practices or drug and cosmetic residues). Micropollutants are characterized as being able, at these very low concentrations, to generate effects on living organisms due to their toxicity, their persistence and their bioaccumulation, or due to organoleptic pollution (taste or odor, in particular relevant when it involves treating water to be made drinkable). The micropollutants are very numerous (more than 110,000 molecules are registered by European regulations) and varied. The variety of pollutants makes it possible to classify them according to their origin, their nature, or else according to their very different chemical properties. Thus, micropollutants may be of natural origin (such as compounds resulting from soil degradation, including geosmin or methylisoborneol or MIB, or bacterial residues), plant origin (such as algae metabolites, including microcystins), or animal or human origin. Micropollutants can be classified according to their nature, such as, for example, polar organic compounds (POC) or metal organic compounds (MOC). Micropollutants may have very different chemical properties, such as detergents, metals, hydrocarbons, pesticides, cosmetics or drugs. The proposed fluid treatment method therefore applies in particular to compounds of the pesticide type and to associated metabolites. This method also applies particularly to solvents. This method applies even more particularly to pharmaceutical residues or industrial residues. All of these categories of pollutants or micropollutants are thus specifically affected by the present invention.

The processing unit implemented within the scope of the invention comprises at least one step of adsorbing pollutants contained in the fluid to be treated. This adsorption step is carried out using an adsorbent (or adsorbent medium).

### Regeneration Method

The regeneration method according to the invention is implemented within the adsorption reactor itself. Thus, the invention makes it possible to limit or even eliminate steps for transporting adsorbent media to be regenerated or media that have already been regenerated.

The regeneration method comprises at least one chemical regeneration step wherein the adsorbent medium bed is brought into contact with a regeneration solution.

Preferably, the regeneration solution comprises water and sodium hydroxide, more preferably the regeneration solution consists of water and sodium hydroxide.

According to one embodiment, the mass concentration of sodium hydroxide in the regeneration solution is less than or equal to 20%, preferably less than or equal to 15%, more preferably ranges from 0.5% to 10%, or even from 1.0% to 5% or from 1.2% to 2.0%.

According to one preferred embodiment, the regeneration solution circulates through the adsorbent medium.

Preferably, during the chemical regeneration step, the regeneration solution is at a temperature of less than or equal to 60° C., preferably ranging from 20° C. to 50° C., even more preferably from 30° C. to 40° C.

In the case where the fluid to be treated is water, the water of the regeneration solution can come from the fluid to be treated.

At the end of the chemical regeneration, the regeneration solution may optionally be reused for one or more other regeneration stages. Indeed, the inventors have discovered that the regeneration step can be implemented using a regeneration solution that has already been used in a preceding regeneration step. Thus, according to one embodiment, the regeneration solution used in the invention is chosen from a new regeneration solution (that is, which has not undergone regeneration) or a regeneration solution that has already been implemented in one or more chemical regeneration steps, for example in 1 to 4 regeneration steps. In the case where the method for treating a fluid is intended to eliminate micropollutants, in particular micropollutants that are difficult to adsorb, the regeneration step may, according to one particular embodiment, be implemented using a regeneration solution that has already been implemented in 1 to 4 regeneration steps.

According to one embodiment, the ratio between the mass in kg of adsorbent media to be regenerated and the volume in liters of regeneration solution used in total ranges from 1/20 to 20/1, preferably from 1/15 to 2/1, or even from 1/10 to 1/1.

According to one embodiment of the regeneration method according to the invention, at the end of contact with the regeneration solution, the adsorbent medium is rinsed using a rinsing solution, which will typically circulate through the adsorbent medium, preferably in the same direction as the regeneration solution. Preferably, the rinsing solution comprises water, preferably consists of water. When the fluid to be treated is water, this rinsing water will preferably be taken from the fluid supply line upstream of the absorption reactor.

According to one embodiment, the regeneration method further comprises a second rinsing step using a second rinsing solution (different from the first rinsing solution) comprising an acidic solution. This step of rinsing with acid makes it possible to reduce the pH. When it is present, this step of rinsing with acid is followed by a step of rinsing with water in order to evacuate the acid.

According to one embodiment, the rinsing step(s) is (are) implemented by circulating the rinsing solution through the adsorbent media bed, preferably continuously. This will then be referred to as dynamic rinsing.

According to one embodiment of the regeneration method according to the invention, the chemical regeneration step further comprises a dewatering step at the end of the contact step with the regeneration solution, said dewatering step being carried out before the rinsing step.

According to one embodiment, the dewatering step lasts from 1 hour to 72 hours, preferably from 5 hours to 48 hours, more preferably from 10 hours to 36 hours.

For this dewatering step, the regeneration solution can be discharged from the regeneration reactor, for example by draining, then the adsorbent medium is kept in the regeneration reactor. The inventors have indeed observed that this dewatering step made it possible to further improve the regeneration method; in particular, this step allows the regeneration solution still present within the adsorbent medium to continue to regenerate the adsorbent medium. During the dewatering, if a small portion of the regeneration solution is drained from the adsorbent medium, this small portion of the regeneration solution can be kept in the regeneration reactor.

According to one embodiment, the regeneration method according to the invention further comprises a step of electrochemical regeneration of the adsorbent medium carried out before or after the chemical regeneration step.

According to the invention, the adsorbent medium bed to be regenerated is a bed of fresh adsorbent medium, generally not yet completely saturated. The target pollutant may be the overall organic matter or a specific micropollutant. Indeed, the regeneration method of the invention is particularly advantageous when it is implemented on a slightly used adsorbent medium.

Within the meaning of the present invention, a bed of fresh adsorbent medium can be characterized alternatively or cumulatively in that:
it has an actual reduction rate of at least one target pollutant ranging from 40% to 80%,
the bed volume treated by said adsorbent medium is from 20,000 BVT to 100,000 BVT, preferably from 30,000 BVT to 75,000 BVT, more preferably from 40,000 to 60,000 BVT,
it has an iodine value ranging from 500 mg/g to 800 mg/g.

Thus, the fresh adsorbent medium intended to be regenerated according to the regeneration method of the invention can be characterized by the actual reduction rate or by the bed treated volume or by the iodine value.

Preferably, the regeneration method according to the invention is implemented periodically and comprises a step of controlling the regeneration frequency based on the freshness of the adsorbent medium. The frequency between two regeneration cycles can be identical or different.

Preferably, the frequency of the implementation of the regeneration method according to the invention is adjusted based on the quality of the adsorbent medium, for example based on the freshness of the adsorbent medium.

The adsorbent medium typically has a certain decrease in these adsorption capacities due to its use as pollutant adsorbent. This reduction in capacities is generally approximated by the concept of productivity, which in turn is likened to the freshness of the sample. The freshness of the sample, similar to its productivity, can thus be counted in bed volume treated (BVT, more commonly referred to as “Bed Volume,” or “BV”). The bed volume treated corresponds to the volume of fluid treated, more particularly water, by the adsorbent relative to the volume of the adsorbent. Thus, the higher the productivity of the adsorbent, the more fluid the adsorbent has treated, and the more it is spent, or old; it can then be assumed that its adsorption capacities have decreased.

According to one embodiment of the invention, the quality of the adsorbent medium is monitored in order to determine the freshness of the adsorbent medium, which can be defined by the actual reduction rate of pollutants and/or by the bed volume treated and/or by the iodine value.

Thus, the regeneration method according to the invention makes it possible to rejuvenate the adsorbent medium since, after regeneration of the adsorbent medium, the latter will be fresher than the adsorbent medium before regeneration.

The measurement of the reduction of a target pollutant of the adsorbent medium can be monitored in order to determine the freshness of the adsorbent medium.

According to one embodiment, the adsorbent medium to be regenerated has an actual reduction rate of at least one target pollutant ranging from 40% to 80%. According to one embodiment, the target pollutant is chosen from organic matter and micropollutants. Preferably, the target micropollutant is chosen from atrazine and atrazine derivatives (such as deisopropylatrazine, hydroxyatrazine, desethylatrazine), metolachlor, metolachlor OXA, metolachlor ESA, metazachlor OXA, chlortoluron, diuron, metaldehyde.

This measurement of the reduction in pollutant can in particular be carried out directly by comparing the concentrations of pollutants upstream and downstream of a fluid treatment using a sample of extracted adsorbent. The reduction in pollutants can also be measured indirectly, by measuring a level of pollutants using, for example, a method for measuring an iodine value or else by chromatography, mass spectrometry or fluorescence spectroscopy (in particular by HPLC, HPLC-HR or HPLC-HR & MS).

This level of pollutants thus determined can then be correlated with an actual concentration of pollutants, for example using predetermined charts, in particular for each pollutant.

In the context of the present invention, a real reduction in at least one pollutant ranging from 40% to 80% means that at the considered time t, 40% to 80% concentration of said pollutant is adsorbed by the adsorbent medium having the quality of time t.

The regeneration method according to the invention can thus comprise a step of measuring the (actual) freshness of the adsorbent medium in the adsorption reactor and the duration before the next regeneration can be determined based on a target freshness to be reached for said adsorption reactor.

According to one embodiment, in order to determine a target freshness at which the charcoal bed must be renewed, the reduction in pollutants of the rejuvenated removed adsorbent is described as “actual reduction of pollutants.” The reduction is qualified as “actual” in that it is determined based on a sample of the adsorbent actually used in the treatment method.

According to a particularly advantageous embodiment, the measurements of reductions in pollutants of the adsorbent medium are carried out by short bed adsorption tests. Short bed adsorption corresponds to the expression Short Bed Adsorber (SBA).

According to this embodiment, the frequency of the regeneration will then be set according to the reduction rate of at least one target pollutant. The regeneration can then be triggered as soon as the actual reduction rate of at least one target pollutant is 40% to 80%, preferably 50% to 70%. According to one embodiment, the target pollutant is chosen from organic matter and micropollutants. Preferably, the target micropollutant is chosen from atrazine and atrazine derivatives (such as deisopropylatrazine, hydroxyatrazine, desethylatrazine), metolachlor, metolachlor OXA, metolachlor ESA, metazachlor OXA, chlortoluron, diuron, metaldehyde.

Other methods for measuring actual reduction of pollutant(s) can be used within the scope of the present invention.

According to one embodiment, the actual reduction in at least one pollutant is determined by measurement and monitoring of at least one pollutant present in the fluid at the inlet of the adsorbent medium and measurement and monitoring of at least one pollutant present in the fluid at the outlet of the adsorbent medium.

Thus, it is possible to implement a continuous analyzer by liquid or gas chromatography, such as an on-line sensor of volatile organic compounds (VOC), at the inlet and at the outlet of the reactor comprising the adsorbent medium. According to this embodiment, the pollutant(s) monitored may be chosen from pesticides, metabolites, solvents, industrial residues, and combinations thereof. Document US2019383779 describes a method for treating and in line monitoring of pollutants.

Regular analyses, for example by liquid or gas chromatography coupled with mass spectrometry, on the fluid at the inlet and on the fluid at the outlet can be implemented in order to compare the evolution of the content of at least one pollutant.

Thus, the difference in concentration of at least one pollutant in the fluid at the inlet and in the fluid at the outlet thus makes it possible to quantify a real reduction of the pollutant(s) tracked.

Alternatively or additionally, the actual reduction in at least one pollutant can be quantified via the monitoring of a pilot unit (adsorption filtration column with the same adsorbent medium as the industrial unit) supplied in parallel with the industrial unit, placed and dedicated specifically to monitoring the difference in the quality of the fluid between the inlet and the outlet of this pilot bed and/or the quality of the medium of this pilot bed.

Alternatively, the freshness of the adsorbent medium can be determined from the theoretical adsorption capacities for a bed volume treated.

According to one embodiment, the target freshness ranges from 20,000 BVT to 100,000 BVT, preferably from 30,000 BVT to 75,000 BVT, more preferably from 40,000 BVT to 60,000 BVT. It will be appropriate to reset the BVT at the end of each implementation of the regeneration method according to the invention.

According to this embodiment, the frequency of the regeneration will then be set based on the bed volume treated. The regeneration will then be able to be triggered once the bed volume treated of the adsorbent medium is from 20,000 BVT to 100,000 BVT, preferably from 30,000 BVT to 75,000 BVT, more preferably from 40,000 BVT to 60,000 BVT.

The measurement of the bed volume treated can be coupled to the measurement of the actual reduction rate, and optionally to the quantity of the fluid to be treated.

The iodine value can also be measured in order to determine the freshness of the adsorbent medium. This iodine value is the amount in milligrams of iodine adsorbed per gram of adsorbent and is used to quantify the adsorbent power of an adsorbent medium. For example, for a new adsorbent, the iodine value may be greater than 950 or 1,000 mg/g (such as for the preferred activated carbon). Conversely, for a used adsorbent, the iodine value may be less than or equal to 500 mg/g. Regeneration of the adsorbent can then lead to an iodine value preferably greater than 600 mg/g or more preferentially greater than 700 mg/g.

According to this embodiment, the frequency of the regeneration will then be set based on the iodine value of the adsorbent medium. The regeneration according to the invention can then be triggered once the iodine value is in the range from 500 mg/g to 800 mg/g.

In the context of the present invention, the iodine value can be determined according to standard ASTM D4607.

Other indexes can be used to determine the freshness of the adsorbent medium to be regenerated. These other indexes include, for example, the methylene blue index, the phenol index, the molasses index, the tannic acid index, and monitoring an acetoxime dye. These other indexes are determined by a measurement on an adsorbent medium sample.

Thus, if the methylene blue index of the adsorbent medium is between 80 ml/g and 120 ml/g, then said adsorbent medium can be considered to be a young adsorbent medium that should be regenerated within the scope of the invention.

The methylene blue index of the adsorbent medium can be determined according to any method known to a person skilled in the art.

If the acetoxime index of the adsorbent medium is between 80 ml/g and 160 ml/g, then said adsorbent medium can be considered to be a young adsorbent medium that should be regenerated within the scope of the invention.

The acetoxime index of the adsorbent medium can be determined according to any method known to a person skilled in the art.

If the molasses index of the adsorbent medium is between 50 ml/g and 150 ml/g, then said adsorbent medium can be considered to be a young adsorbent medium that should be regenerated within the scope of the invention.

The molasses index of the adsorbent medium can be determined according to any method known to a person skilled in the art.

According to one embodiment, the invention relates to a method for regenerating a bed of adsorbent medium in an adsorption reactor, implemented in a fluid treatment unit, said fluid comprising at least 95 wt % of water, relative to the total weight of the fluid, said bed of adsorbent medium during the regeneration being a fresh adsorbent medium (also called “unsaturated”), said regeneration method comprising at least one chemical regeneration step wherein the bed of adsorbent medium is brought into contact with a regeneration solution comprising water and sodium hydroxide, said bed of fresh adsorbent medium being characterized in that:
it has an actual reduction rate of at least one target pollutant ranging from 40% to 80%, and/or
the bed volume treated by said adsorbent medium is from 30,000 BVT to 75,000 BVT, and/or
it has an iodine value ranging from 500 mg/g to 800 mg/g.

### Method for Treating a Fluid

The invention also relates to a method for treating a fluid in a treatment unit comprising at least one stop phase and at least one production phase, wherein said at least one production phase comprises the passage of a fluid to be treated through an adsorbent medium bed within an adsorption reactor and wherein said at least one stop phase comprises implementing a regeneration method according to the invention.

The characteristics of the fluid, of the adsorbent medium and of the treatment unit defined in the context of the regeneration method are valid for the method for treating a fluid according to the invention. Thus, preferentially, the adsorbent medium is chosen from granular activated carbon, anion exchange resin, biomaterials, molecularly imprinted polymers and mineral materials; preferably the adsorbent medium is a granular activated carbon. Also, preferentially, the fluid to be treated is water.

According to one embodiment, the treatment method according to the invention further comprises at least one stop phase wherein the adsorbent medium bed is washed using a washing solution.

When a stop phase comprises a regeneration step according to the invention, then this stop phase will not comprise a phase of washing the adsorbent medium, since rinsing may be provided during the regeneration method.

According to one embodiment, the method for treating a fluid comprises a step of checking the quality of the adsorbent medium, for example by measuring the freshness of the adsorbent medium.

Typically, the fluid treatment method according to the invention comprises a step of measuring the freshness of the adsorbent medium, preferably implemented by measuring the actual reduction rate of at least one target pollutant by the adsorbent medium, and/or by measuring the bed volume treated by the adsorbent medium, and/or by measuring the iodine value of the adsorbent medium.

According to one embodiment, the treatment method further comprises a step of determining at least one target pollutant. According to one embodiment, the target pollutant is chosen from organic matter and micropollutants. Preferably, the target micropollutant is chosen from atrazine and atrazine derivatives (such as deisopropylatrazine, hydroxyatrazine, desethylatrazine), metolachlor, metolachlor OXA, metolachlor ESA, metazachlor OXA, chlortoluron, diuron, metaldehyde.

According to one embodiment, the treatment unit implemented in the context of the treatment method according to the invention comprises at least two adsorption reactors, preferably at least three adsorption reactors. According to this embodiment, the regeneration method can be implemented synchronously or non-synchronously on all of the regeneration reactors, preferably non-synchronously in order to keep some reactors in the production phase when other reactors are in the stop phase during a regeneration according to the invention.

According to one embodiment, the method for treating a fluid according to the invention is implemented in the context of an upward flow activated carbon treatment method, as disclosed in the aforementioned document FR 3003477, and to which reference is made.

According to one embodiment, the method for treating a fluid according to the invention is implemented in the context of a downward flow activated carbon treatment method.

The present invention can also implement, in parallel with the treatment unit, a pilot unit wherein the same fluid to be treated circulates in a sample of the same adsorbent medium. Said pilot unit thus typically comprises at least one means for measuring the freshness of the adsorbent medium; said means for measuring the freshness can thus be implemented on the adsorbent medium or on the treated fluid (when the adsorbent medium leaves the pilot unit). The pilot unit will thus be very representative of the “actual” treatment unit and will then make it possible to determine the freshness of the adsorbent medium and, based on the freshness, to trigger a regeneration step as defined in the invention for the treatment unit according to the invention.

### Fluid Processing Unit

The invention also relates to a fluid treatment unit for implementing the treatment method according to the invention, said treatment unit comprising:
at least one adsorption reactor for pollutants contained in the fluid to be treated, the reactor comprising an adsorbent medium within it, and
means for measuring the freshness of the adsorbent medium.

The characteristics of the fluid, of the adsorbent medium and of the treatment unit defined in the context of the regeneration method are valid for the unit for treating a fluid according to the invention. Thus, preferentially, the adsorbent medium is chosen from granular activated carbon, anion exchange resin, biomaterials, molecularly imprinted polymers and mineral materials; preferably the adsorbent medium is a granular activated carbon.

According to one embodiment, the treatment unit comprises at least two adsorption reactors, preferably at least three adsorption reactors. According to this embodiment, the regeneration method can be implemented synchronously or non-synchronously on all of the regeneration reactors, preferably non-synchronously in order to keep some reactors in the production phase when other reactors are in the stop phase during a regeneration according to the invention.

According to one embodiment, the treatment unit comprises a tank intended in particular for the preparation of the regeneration solution, said tank typically comprising heating means making it possible to heat the regeneration solution before contact with the adsorbent medium to be regenerated.

Preferably, the tank for preparing the regeneration solution feeds the adsorption reactor. The treatment unit according to the invention may comprise a circulation loop between the regeneration solution preparation tank and the adsorption reactor.

When the regeneration is finished, the regeneration solution preparation tank can be emptied and replaced by the rinsing solution (implemented in the context of the regeneration method according to the invention).

According to one embodiment, the means for measuring the freshness of the adsorbent medium are chosen from a UV spectroscope, a device for measuring dissolved organic carbon, a short bed adsorber test device, and combinations thereof.

### EXAMPLES

### Example 1: Treatment Method According to the Invention

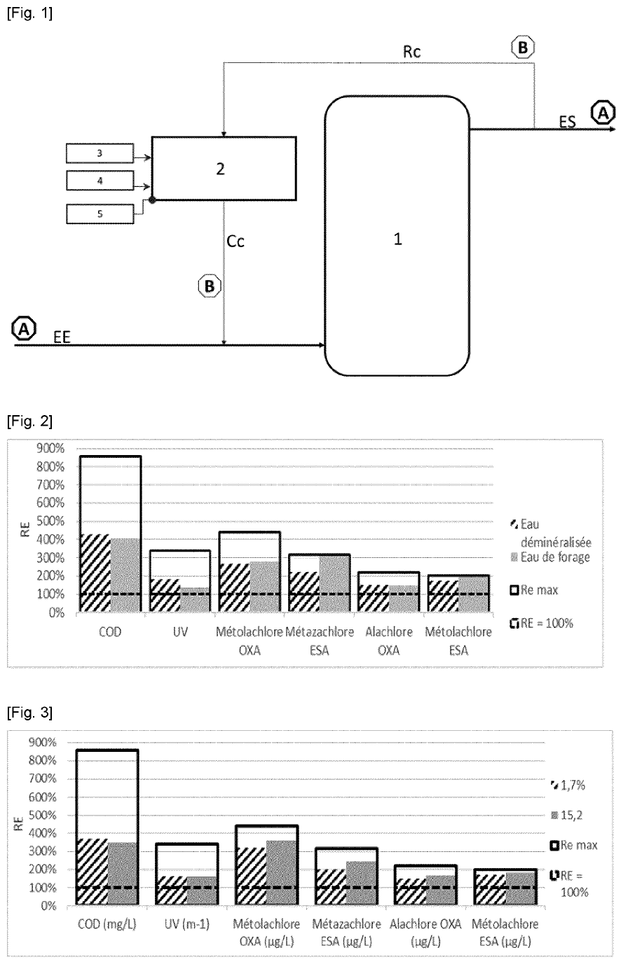

FIG. 1 is non-limiting and shows an embodiment of a treatment method according to the invention, with an ascending flow of fluid to be treated:

### A. Filtration Operation:

The inlet water (EE) of the adsorbent medium (GAC, for example) is introduced into at least one GAC reactor 1, passes through at least one activated carbon bed and exits via the line ES (outlet water line).

### B. Regeneration:

The medium/regeneration solution contact time is 1 hour in closed circuit, circulation (Cc) and recirculation (Rc). The temperature of the regeneration solution is preferably 40° C. (using a thermal resistance 5, for example) in a device for preparing the regeneration solution 2, and the regeneration solution consists of 1.7% sodium hydroxide 3 (prepared for example with demineralized water 4).

At the end of the regeneration, the regeneration solution can be emptied (extracted from the reactor) and then removed or directed to a storage tank (for possible subsequent use).

Typically, the adsorbent medium bed is then “drained” under static conditions, preferably for 48 h.

### Example 2: Regeneration Tests

### Protocol:

These tests were carried out with a GAC adsorbent medium having a freshness of about 50,000 VV.

The regeneration solutions are obtained by diluting a 35% sodium hydroxide solution. 100 g of GAC are introduced to be regenerated with 800 ml of the solution prepared in a 1 L bottle (except for the example “effect of the mass ratio of GAC/regeneration solution volume,” where the amount of solution is 200, 500 or 800 ml). The bottles are placed in a rotary stirrer, where they are mixed at a speed of about 15 revolutions per minute.

For all tests, 100 g of GAC is weighed. 100 g of drained GAC corresponds to between 100 ml and 125 ml, depending on the degree of moisture of the GAC.

After regeneration, it is possible to rinse the GAC in order to eliminate the sodium hydroxide, which can still potentially act within the medium, but especially to reduce the pH of the water at the outlet of the filter or to remove GAC, the dissolved desorbed compounds from the pores.

Two rinsing methods are studied in these tests: static rinsing and circulation rinsing. In both cases, the GAC is brought into contact with a certain volume of drilling water or demineralized water, one or more times.
Static Rinsing: the GAC is placed in a one-liter bottle with water, without movement for several hours.
Circulation Rinsing: The GAC is placed in a column with water. The water is pumped via the top of the column and then reinjected into the bottom of the column (or discharged) via a peristaltic pump. The pump is configured to deliver a flow rate corresponding to a speed equivalent to that of the pilot (15 m/h).

The SBA, or Short Bed Adsorber Adsorber, is an adsorption test on non-ground GAC, in mini-columns, under operating conditions close to those applied at the pilot scale. New, spent or regenerated GAC is placed in cartridges through which the raw water doped with micropollutants is passed (feed matrix). The inlet water and the outlet water of each cartridge are analyzed to determine the reduction of the micropollutants by the GAC, thus characterizing the adsorption capacities of the tested GAC. The peristaltic pump allows the passage of water at a speed set for a target contact time in the column, in ascending or descending flow.

In order for the conditions of the SBA test to be representative of those of the site, an equivalent contact time must preferably be maintained, using the same inlet matrix and passing a minimum volume of 200 VV.

The raw water at the SBA inlet is doped at 2.5 μg/L for micropollutants, of the pesticide or metabolite type: Metolachlor OXA, Metazachlor ESA, Alachlor OXA, Metolachlor ESA. The water is transferred to the GAC cartridges, and is analyzed at their inlet and outlet. For each sample, the concentration of micropollutants and organic matter (DOC and UV absorbance) is measured.

The concentrations of the water at the inlet and outlet of the control medium (GAC before regeneration, partially saturated for the adsorption of certain micropollutants) and of the reference medium (new GAC) are also analyzed in order to determine the reduction rate, the coefficient of efficiency (RE) and the maximum regeneration efficiency coefficient (max RE) for the micropollutants and the organic matter.

The 4 micropollutants cited were selected because have low adsorption, that is, that they are associated with the holes of GAC filters for media productions or ages ranging between 50,000 and 100,000 VV.

Organic matter (OM) is not harmful per se, but has numerous consequences on water treatment and appearance. When it reacts with oxidants (ozone, chlorine, etc.), it is at the origin of disinfecting by-products, it discolors water and it is likely to saturate filter media.

In competition with micropollutants (concentration of a microgram per liter), OM (concentration of around a milligram per liter) is also adsorbed on the GAC and can block access to some pores.

It is therefore useful to reduce the organic matter to avoid saturating the GAC; the OM is monitored by UV spectroscopy (at 254 nm) and measurement of the DOC (Dissolved Organic Carbon). The higher the UV and DOC values, the more OM is present.

The DOC is measured after passage through a filter (COT-meter).

### Evaluation of the Performance

The regeneration efficiency recovery coefficient (RE) was chosen, to quantify the performance of the GAC regeneration, with respect to the adsorption of the OM and of the micropollutants monitored in the project. It is calculated from the reduction of the monitored compound, on the regenerated GAC and on the control GAC. These quantities are therefore specific to each micropollutant (A).

The reduction of a compound:

$$A = \frac{{C}_{0} - C}{{C}_{0}} ,$$

where C₀ is the concentration the compound at the inlet of the GAC filter and C is the concentration of the compound at the outlet of the GAC filter.

The regeneration efficiency coefficient

$$RE = \frac{{A}_{REGENERATED CAG}}{{A}_{CONTROL GAC}}$$

where A is the reduction of a compound.

The maximum regeneration efficiency coefficient

$$REmax = \frac{{A}_{REGENERATED GAC}}{{A}_{NEW GAC}}$$

To interpret the results, the RE of the regenerated GAC is compared to the limit RE=100% and to the RE max for a given micropollutant, following the indications:
If RE<100%, the adsorption capacity of the regenerated GAC has decreased.
If RE=100%, the regeneration has had no impact on the adsorption capacity.
If RE>100%, the adsorption capacity of the regenerated GAC has increased.
If RE=RE max, the adsorption capacity found is equivalent to that of the new GAC. This corresponds to the maximum possible value.

### Effect of the Nature of the Water

A regeneration step as described in this example was carried out for 7 h, with a 1.7% concentrated sodium hydroxide solution using either demineralized water or drilling water (water from the site to be treated). The coefficient of efficiency RE was determined for different pollutants and is shown in [FIG. 2].

The results show that the nature of the water has little impact on the regeneration. Thus, preferably, the regeneration solution used in the invention comprises water originating from the treatment site, for example fluid to be treated in the case where the fluid to be treated is water, such as drilling water.

### Effect of the Sodium Hydroxide Concentration

A regeneration step as described in this example was carried out for 7 h, with a sodium hydroxide solution concentrated at 1.7% and 15.2%. The coefficient of efficiency RE was determined and is shown in [FIG. 3]. The results of FIG. 3 show that there is a very small difference between a concentration of 1.7% and a concentration of 15.2%.

### Effect of the Mass Ratio of GAC/Volume of Regeneration Solution

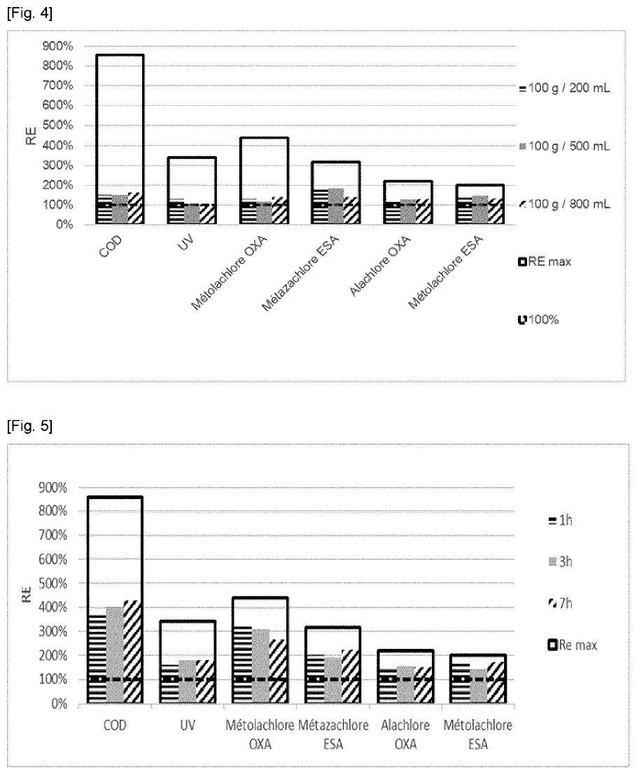

A regeneration step as described in this example was carried out with 100 g of GAC and different volumes of regeneration solution at 1.7%: 200 mL, 500 mL and 800 mL. The coefficient of efficiency RE was determined and is depicted in [FIG. 4]. The results of FIG. 4 show that the volume of regeneration solution has little impact on the regeneration. Thus, the method has the advantage of being able to be implemented with a limited quantity of regeneration solution, thus decreasing the reagents and the discharges.

### Effect of Contact Time

A regeneration step as described in this example was carried out with different sodium hydroxide/GAC contact times under stirring), with a regeneration solution at 1.7%. The coefficient of efficiency RE was determined and is shown in [FIG. 5]. The results of FIG. 5 show that the regeneration time has little impact on the efficiency of the regeneration.

### Effect of Rinsing

The effect of rinsing after the regeneration step was evaluated.

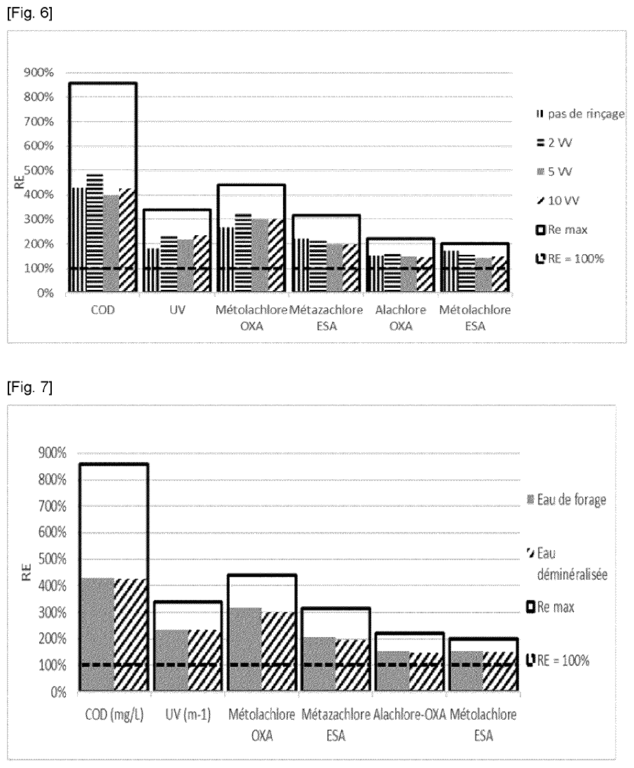

Static rinsing was carried out for 7 h (after a 7 h regeneration with a 1.7% solution). The pH of the rinsing solution (demineralized water) decreases when the rinsing VV number increases. Thus, for 2 VV, the pH is 10.5; for 5 VV, the pH is 9.5; and for 10 VV, the pH is 9. The coefficient of efficiency RE was determined and is depicted in [FIG. 6]. The results of [FIG. 6] show that rinsing has little impact on the regeneration efficiency.

Dynamic rinsing with closed circulation was carried out for 7 h (after a 7 h regeneration with a 1.7% solution). The pH of the rinsing solution (water from the site) decreases when the rinsing VV number increases. Thus, for 2 VV, the pH is 11; for 5 WV, the pH is 9.5; and for 10 VV, the pH is 9.

### Effect of the Rinsing Water

Static rinsing was carried out with demineralized water or with water from the site of 10 VV for 7 h (after a 7 h regeneration with a 1.7% solution). The coefficient of efficiency RE was determined and is depicted in [FIG. 7].

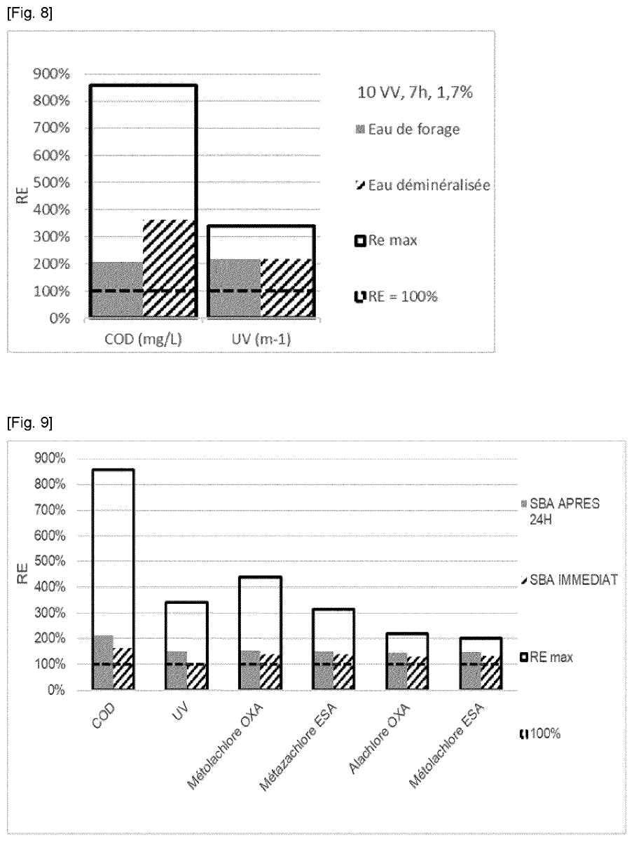

Dynamic rinsing (closed circuit) was carried out with demineralized water or with water from the site of 10 VV for 7 h (after a 7 h regeneration with a 1.7% solution). The coefficient of efficiency RE was determined and is depicted in [FIG. 8].

The results of FIG. 7 and FIG. 8 show that the nature of the rinsing has little impact on the regeneration efficiency. Thus, according to a preferred embodiment of the invention, the rinsing water is water from the site (drilling water) originating from the fluid to be treated.

### Effect of a Dewatering Step

The inventors have discovered that a dewatering step (waiting time) before the rinsing step or the SBA test could be implemented in order to improve the efficiency of the regeneration.

An SBA test was carried out immediately after a 1 h regeneration with a 1.7% regeneration solution and 24 h after this regeneration in order to evaluate the effect of the dewatering step. The coefficient of efficiency RE was determined and is depicted in [FIG. 9]. The results of FIG. 9 show that waiting for 24 h before carrying out an SBA test on the sample provides a better adsorption capacity than when it is tested immediately in SBA. This result suggests that the sodium hydroxide in the “dewatering” medium continues to act during this static phase after the initial phase of sodium hydroxide/medium contact with stirring. The SBA test methodology applies a stabilization time of the sample of 200 VV, which is similar to a rinsing of the tested medium.

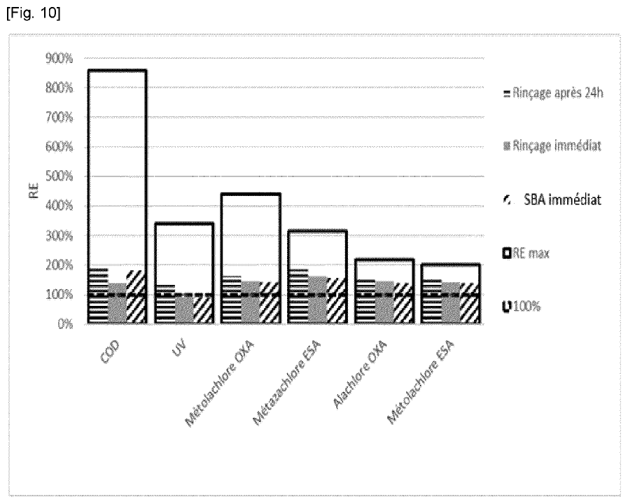

A rinsing step was carried out immediately after a 1 h regeneration with a 1.7% regeneration solution or a rinsing step was carried out 24 h after a 1 h regeneration with a 1.7% regeneration solution. The coefficient of efficiency RE was determined and is depicted in [FIG. 10], where the result without rinsing with an immediate SBA is also indicated. The results of FIG. 10 show that a dewatering step before the rinsing step makes the regeneration more efficient.

The invention thus proposes an efficient regeneration method, implementing a reduced amount of reagents and which can use the water from the site as rinsing solution and/or in the regeneration solution. In particular, the sodium hydroxide concentration can be less than 2% in the regeneration solution, in particular when the regeneration method comprises a dewatering (waiting) step before rinsing.

1. A method for regenerating a bed of adsorbent medium in an adsorption reactor, implemented in a fluid treatment unit, said bed of adsorbent medium prior to regeneration being a fresh adsorbent medium, said regeneration method comprising at least one chemical regeneration step wherein the bed of adsorbent medium is brought into contact with a regeneration solution, said bed of fresh adsorbent medium being characterized in that:
it has an actual reduction rate of at least one target pollutant ranging from 40% to 80%, and/or
the bed volume treated by said adsorbent medium is from 20,000 to 100,000 BVT, preferably from 30,000 to 75,000 BVT, more preferably from 40,000 to 60,000 BVT, and/or
it has an iodine value ranging from 500 mg/g to 800 mg/g.

2. The regeneration method according to claim 1, wherein the regeneration solution comprises an aqueous sodium hydroxide solution, preferably consists of an aqueous sodium hydroxide solution.

3. The regeneration method according to claim 1, wherein the regeneration solution is circulated in a closed loop through the activated carbon bed within the adsorption reactor.

4. The regeneration method according to claim 1, wherein the regeneration solution is at a temperature of less than or equal to 60° C., preferably ranging from 20° C. to 50° C., even more preferably from 30° C. to 40° C.

5. The regeneration method according to claim 1, wherein at the end of contact with the regeneration solution, the adsorbent medium bed is rinsed using a rinsing solution, said rinsing solution preferably comprising water, or even consisting of water.

6. The regeneration method according to claim 5, wherein the chemical regeneration step further comprises a dewatering step at the end of the contact step with the regeneration solution, said dewatering step being carried out before the rinsing step.

7. The regeneration method according to claim 1, further comprising a step of electrochemical regeneration of the adsorbent medium carried out before or after or during the chemical regeneration step.

8. The regeneration method according to claim 1, wherein:
the fluid to be treated is chosen from water, urban effluent, industrial effluent; preferably, the fluid to be treated is water, and/or
the adsorbent medium is chosen from granular activated carbon, anion exchange resin, biomaterials, molecularly imprinted polymers and mineral materials; preferably the adsorbent medium is a granular activated carbon.

9. The regeneration method according to claim 1, implemented periodically, comprising a step of determining the next regeneration step based on the freshness of the adsorbent medium, characterized by the reduction rate of at least one target pollutant, and/or by the volume of bed treated and/or by the iodine value of the adsorbent medium.

10. A method for treating a fluid in a treatment unit comprising at least one stop phase and at least one production phase, wherein said at least one production phase comprises the passage of a fluid to be treated through an adsorbent medium bed within an adsorption reactor and wherein said at least one stop phase comprises implementing a regeneration method according to claim 1.

11. The treatment method according to claim 10, further comprising at least one other stop phase wherein the adsorbent medium is washed using a washing solution, said other stop phase not comprising regeneration of the adsorbent medium.

12. The treatment method according to claim 10, further comprising a step of measuring the freshness of the adsorbent medium, preferably implemented by measuring the actual reduction rate in at least one target pollutant by the adsorbent medium, and/or by measuring the bed volume treated by the adsorbent medium, and/or by measuring the iodine value of the adsorbent medium.

13. A fluid treatment unit for implementing the method according to claim 10, said treatment unit comprising:
at least one adsorption reactor for pollutants contained in the fluid to be treated, the reactor comprising an adsorbent medium within it, and
means for measuring the freshness of the adsorbent medium.

14. The treatment unit according to claim 13, wherein the adsorbent medium is chosen from granular activated carbon, anion exchange resin, biomaterials, molecularly imprinted polymers and mineral materials; preferably the adsorbent medium is a granular activated carbon.

15. The treatment unit according to claim 13, wherein the means for measuring the freshness of the adsorbent medium are chosen from a UV spectroscope, a device for measuring dissolved organic carbon, a short bed adsorber test device, and combinations thereof.
